(19) United States
(12) Patent Application Publication
(10) Pub. No.: US 2020/0245787 A1
(43) Pub. Date: Aug. 6, 2020

(54) FOOD SHIELD BALL JOINT

(71) Applicant: Brass Smith Innovations, LLC (BSI Designs), Wilmington, DE (US)

(72) Inventors: Geoffrey R. Quinter, Denver, CO (US); Wayne Sirmons, Denver, CO (US); Shane Korthuis, Denver, CO (US); Schuyler Livingston, Denver, CO (US); Dusty Terry, Denver, CO (US); Marc Hanchak, Denver, CO (US)

(21) Appl. No.: 16/781,692

(22) Filed: Feb. 4, 2020

Related U.S. Application Data
(60) Provisional application No. 62/801,523, filed on Feb. 5, 2019.

(51) Int. Cl. A47F 10/06; F16C 11/06; F16C 11/10

(52) U.S. Cl. CPC A47F 10/06; A47F 2010/065; F16C 11/106; F16C 11/06

(57) ABSTRACT

A food shield panel support bracket or food shield system having a stand, the food shield panel support bracket and a food shield. The food shield panel support bracket includes a ball joint positioned between an attachment to the stand an attachment to the food shield panel. The ball joint includes at least one hemispherical surface providing for the adjustment of the angular orientation of any attached food shield panel relative to the stand. Methods of adjusting the position or orientation of a food shield panel are also disclosed.

### RELATED APPLICATIONS

This application claims priority to U.S. Patent Application Ser. No. 62/801,523 (the '523 application), filed on Feb. 5, 2019 by Geoffrey R. Quinter et al. (attorney docket no. 0702.07PR), entitled, “FOOD SHIELD BALL JOINT,” the entire teachings of which are incorporated herein by reference in its entirety for all purposes.

### FIELD OF THE INVENTION

The present disclosure relates to systems, apparatus and methods for implementing a food shield, and more particularly to systems, apparatus and methods for implementing a food shield with an adjustable panel.

### BACKGROUND OF THE INVENTION

Food shields, also sometimes called sneeze guards, are used in a variety of settings. Typically, a food shield includes at least one transparent panel that is suspended over a buffet, smorgasbord, salad bar, retail display, or other kind of food display. The food shield serves to attractively display the food while protecting the food from falling debris or other contamination. Various health and safety codes may specify the required position of a food shield in relation to a commercial or institutional food display. Within the range of code-required food shield configurations however, it is desirable to implement a food shield in a manner that is attractive and consistent with the surrounding architecture. It can be difficult, using conventional food shield structures, to install a system which appears to be custom-made for the location.

Food shields typically include brackets extending from a stand or post to support a transparent panel at a suitable height. Many custom installations include food shield systems positioned to conform to architectural features or configured to enhance customer traffic flow. These systems are often not simple linear structures. On the contrary, a food shield system may include many countertops and cabinets, referred to herein as display modules, positioned at selected angles with respect to each other, in various angled, rectangular, polygonal, horseshoe, curved or other non-linear overall configurations. Positioning uniformly shaped transparent panels over a non-linear assembly of display modules can be difficult. The embodiments disclosed herein are directed toward overcoming one or more of the above problems.

### SUMMARY

Various embodiments disclosed herein provide improved apparatus and methods for implementing a food shield. Certain disclosed embodiments provide apparatus for implementing a food shield with an adjustable panel. One representative example is a food shield system having a stand including one or more posts. The system also includes a panel support bracket attached to a post and also attached to a food shield panel away from the post.

The panel support bracket may include a ball joint positioned between the attachment to the post and the attachment to the food shield panel, wherein the ball joint includes at least one hemispherical surface providing for the adjustment of the angular orientation of the panel relative to the stand without moving or articulating the attachment between the panel support bracket and the post.

In some embodiments, the panel support bracket may also include a male hemispherical surface on a first ball joint element, and a female hemispherical surface on a separate second ball joint element, wherein the male and female hemispherical surfaces of the first and second ball joint elements are operationally engaged with each other by a threaded element extending through the first ball joint element and the second ball joint element.

The ball joint may also include a structured surface on one of the first and second ball joint elements opposite the male or female hemispherical surface, and a mating structured surface on a third ball joint element, also held in moveable engagement with the first or second ball joint element by the threaded element extending through all three ball joint elements. Articulation of the panel support bracket at the structured surfaces provides for adjustment of the position of the food shield panel relative to the attachment of the panel support bracket to the post.

In the above embodiment, the system may also include a knob threaded over or in to the threaded element, such that threading or unthreading the knob with respect to the threaded element provides for the moveable engagements between the first, second and third ball joint elements to be selectively loosened or tightened to loosen or hold the first, second, and third ball joint elements together.

The panel support bracket may be provided with a pivot assembly positioned between the ball joint and the attachment to the food shield panel, such that articulation of the pivot assembly provides for adjustment of the angular orientation of the food shield panel around the lengthwise axis of the financial panel.

In some embodiments, the panel support bracket is attached to a flat surface of the post with screws. In other embodiments, the panel support bracket is attached to the post with an adjustable clamp providing for adjustment of the vertical position of the panel support bracket along the post. If provided, the adjustable clamp may include a first clamp portion and a second clamp portion held together by engagement between one or more slots formed in one or each of the first and second clamp portions and mating keyways formed in the other of the first and second clamp portions.

The adjustable clamp may be provided with a cam lever and a pressure sheath positioned to be pressed against the post by the cam lever to selectively tighten or loosen the adjustable clamp from the post. The pivot assembly, ball joint, and panel attachment may be provided with knobs, which in conjunction with the cam lever can provide an entire system where the installation, removal, and all adjustments of the food shield panel position or orientation may be accomplished without the use of tools.

Alternative embodiments include a food shield panel support assembly as described above or methods of providing and adjusting a food shield panel.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### BRIEF DESCRIPTION OF THE DRAWINGS

FIG. 1 is a perspective view of a food shield with panel support brackets having ball joints as disclosed herein.

FIG. 2 is a plan view of a panel support bracket including a ball joint.

FIG. 3 is a perspective view of the panel support bracket of FIG. 2.

FIG. 4 is an alternative perspective view of the panel support bracket of FIG. 2.

FIG. 5 is an assembled view of a ball joint.

FIG. 6 is an exploded view of the ball joint of FIG. 5.

FIG. 7 includes various views of a ball joint base.

FIG. 8 includes various views of a ball joint hemispherical element.

FIG. 9 includes various views of a ball joint cup element.

FIG. 10 includes various views of a ball joint adjustment plate.

FIG. 11A is a perspective view of an alternative embodiment of support arm featuring a ball joint.

FIG. 11B is an exploded perspective view of the support arm featuring a ball joint of FIG. 11A.

FIG. 12A is a perspective view of an alternative embodiment of support arm featuring a ball joint.

FIG. 12B is an exploded perspective view of the support arm featuring a ball joint of FIG. 12A.

### DETAILED DESCRIPTION OF THE EMBODIMENTS

In the following description, for the purposes of explanation, numerous specific details are set forth in order to provide a thorough understanding of the described embodiments. It will be apparent to one skilled in the art, however, that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

The embodiments disclosed herein provide a variety of food shields, also known as sneeze guards, having various adjustment features that permit the food shields to be used in a wide variety of settings. Such adjustment features may provide the ability to adjust the angular orientation of a panel supporting bracket and any attached panel with respect to one or more supporting posts.

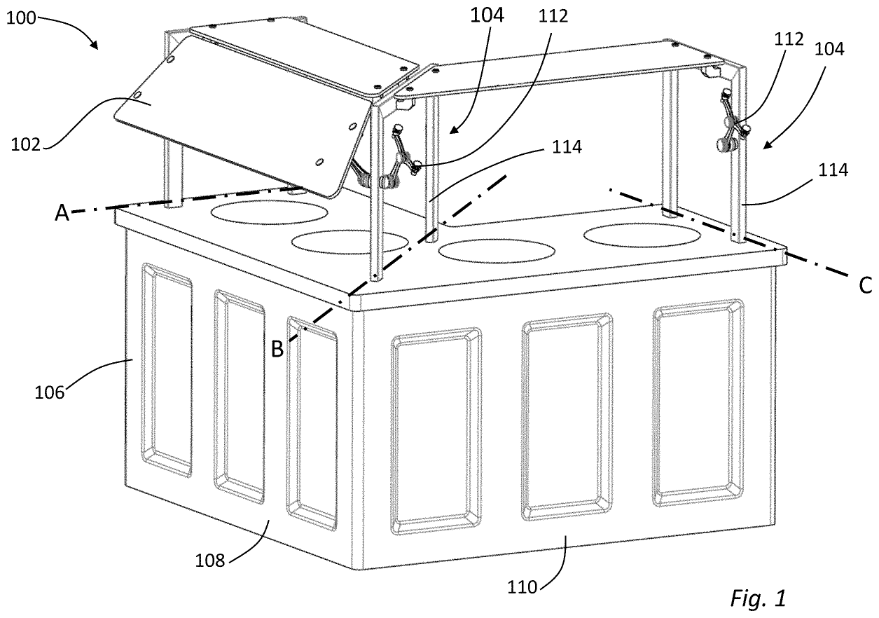

FIG. 1 is a perspective view of one example of a food shield system 100 having a panel 102 supported by a stand 104 over a base 106. The illustrated base 106 is implemented with two modules 108, 110 forming a right-angle corner. Thus, two separate panels 102 are required to shield both the left module 108 in the right module 110 of the base 106. Only the left panel 102 is shown in FIG. 1. The right panel is not shown to provide ready visualization of the stand 104 and panel support bracket 112 components.

The base 106 may be generally configured as a cabinet, table, bar, counter, or the like. The base 106 may include various configurations of trays, receptacles, openings, heating elements, cooling elements, or similar apparatus to permit the attractive and sanitary display of food items. The food shield system 100 may be used in a variety of settings, for example at a buffet, smorgasbord, salad bar, other kind of food display, other retail display, or the like. The food shield system 100 may be as large or complicated as required and can include multiple bases 106, multiple panels 102, and multiple stands 104 in any configuration. In use, the food shield system 100 protects food or other merchandise from falling debris or other contamination. The panels 102 are therefore typically clear or transparent to enable customers to view displayed food or other products. Representative panels 102 might be fabricated from glass, transparent acrylic, transparent polycarbonate, or similar materials.

A panel 102 is typically connected to at least one stand 104 with at least one panel support 112. As shown in FIG. 1, a pair of panel supports 112, attached to adjacent stands 104, can be configured to each hold opposing sides of a panel 102. In alternative configurations, one panel support 112 can be configured to hold one side of a panel 102 extending away from a single stand 104. Any combination of stands 104, panel supports 112, panels 102, and bases 106 is within the scope of this disclosure.

As shown in FIG. 1, each panel support 112 is attached to a stand 104 at an upright post 114. Each stand 104 includes front and back upright posts 114 oriented along one of lines A, B, or C. As illustrated in FIG. 1, each stand 104 is angled 45 degrees with respect to adjacent stands. Therefore, each of the lines A, B, and C is angled 45 degrees with respect to the adjacent lines. This configuration causes the end stands 104, oriented along lines A and C, to be angled with respect to each other by 90 degrees. This is consistent with the right-angle configuration of the base 106. The upright posts 114 have a rectangular cross-section in the FIG. 1 embodiment. Therefore, panel supports 112 mounted perpendicular to the inside edges of the center posts 114 would not be parallel to any panel supports 112 mounted perpendicular to the inside edges of outside posts 114. The panel support embodiments disclosed below include a ball joint permitting the angular adjustment of the panel support 112 with respect to a corresponding post 114. The embodiments disclosed herein are well-suited for use with rectangular or square posts 114, but could be implemented with posts having circular, polygonal or other cross-sections.

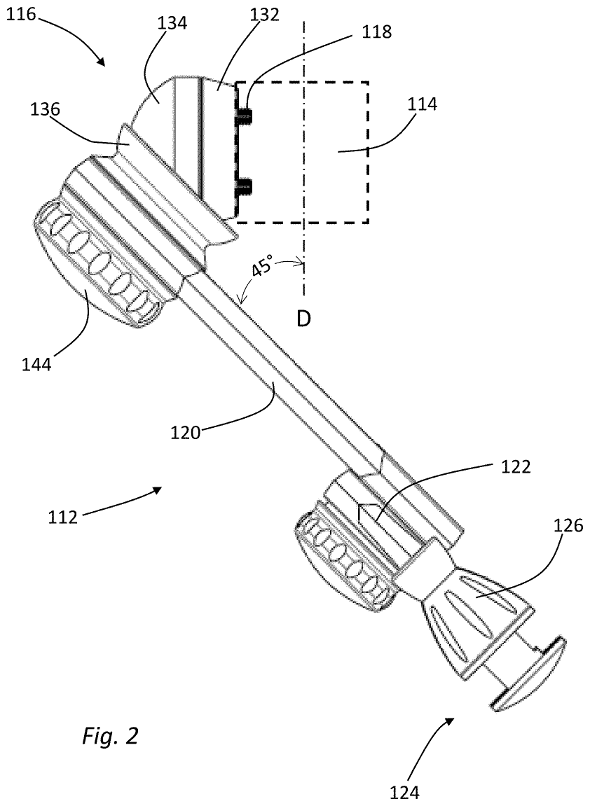

FIGS. 2-12 show various embodiments of a panel support 112 including a ball joint 116 providing for the adjustment of the overall angular orientation or position of a panel support 112 with respect to a post 116. If the post or a similar stand element is positioned vertically, the angular adjustment provided by the panel support 112 may be in a horizontal plane. Alternatively, if the post 116 is positioned at some angle away from vertical, the angular adjustment provided by the ball joint 116 of the panel support 112 may be in a plane perpendicular to a lengthwise axis of the post. Alternatively, the range of adjustment provided by a ball joint 116 may be non-planar, or in a plane offset at a selected angle from any axis defined by a stand 104 or post 116. FIGS. 2-4 show a first embodiment of a panel support 112 including a ball joint 116 which is configured for the direct attachment to a post 114 having a square, rectangular, polygonal or other cross-section with at least one flat side.

FIG. 2 is a plan view of a panel support 112 which can be attached to a post 114 using bolts or screws 118. The post 114 is shown in dotted lines in FIG. 2. The panel support 112 includes a ball joint assembly 116, described in detail below, which permits the support arm 120 to be positioned at a selected angle with respect to a line D drawn through the center of the post 114. The angle illustrated in FIG. 2 is 45 degrees. This angle is not limiting, the ball joint 116 can, in certain embodiments, permit the support arm 120 to be angled with respect to the post 114 at any angle within the mechanical range provided by the ball joint.

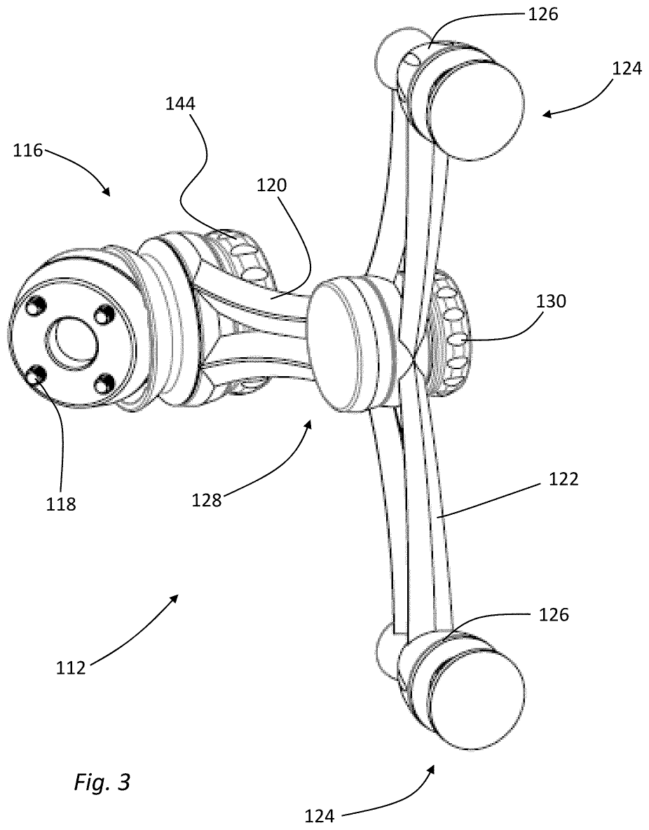

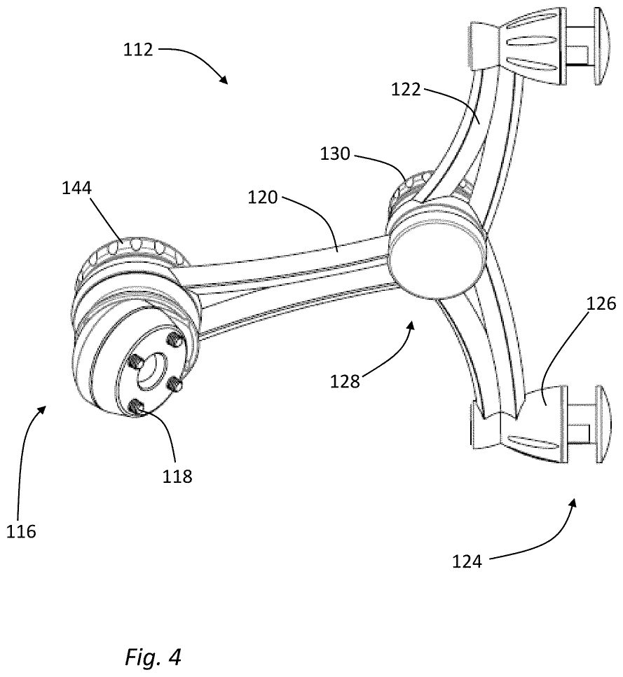

The panel support 112 includes a panel bracket element 122, best seen in FIGS. 3 and 4. The panel bracket element 122 terminates in a pair of panel coupling structures 124. The panel coupling structures 124 are, in use, engaged with a panel 102 typically through hole in the panel as shown in FIG. 1. Secure engagement with a panel 102 may be accomplished without the use of tools by tightening threaded knob 126. The vertical/horizontal orientation of the panel 102 relative to the arm 120 may be adjusted by pivoting the panel bracket element 122 around a pivot assembly 128 and tightening same with threaded knob 130 or a similar mechanism.

As noted above, the ball joint 116 allows the angular orientation of the entire panel support 112 to be adjusted with respect to a post 114. Specifically, the angular orientation of the entire panel support may be adjusted generally around a lengthwise axis running through a post 114. As detailed below, the specific plane of angular adjustment may be further adjusted to be angled above, below or parallel to a plane perpendicular to the lengthwise post axis.

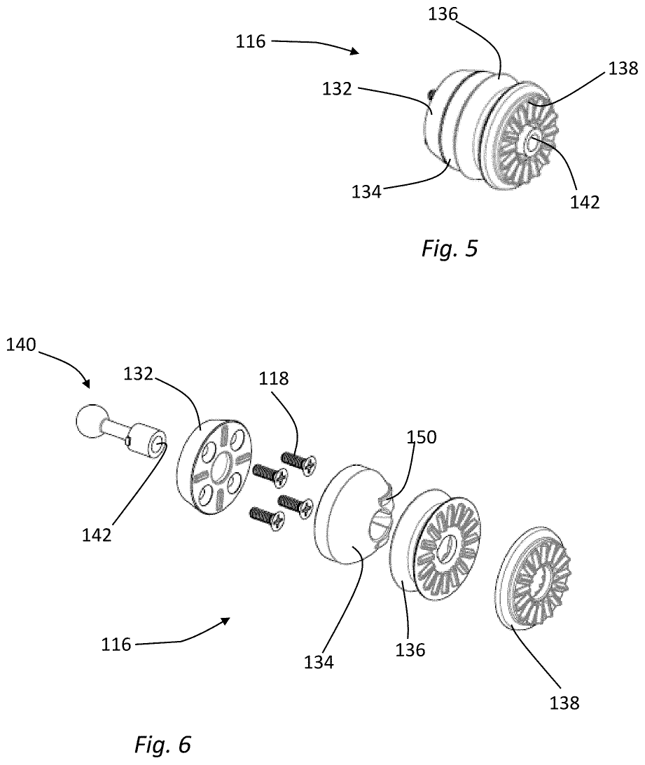

FIGS. 5-10 show various elements of a ball joint 116. The FIGS. 5 and 6 embodiment includes a base 132 which is directly attached to a flat surface on a post 114 using machine screws 118. Angular adjustment is facilitated by a hemisphere element 134 and a mating cup element 136. Adjustment of the vertical orientation of the support arm 120 in a plane parallel to the lengthwise axis of a post 114 is provided by adjustment plate 138. The adjustment plate 138 may be a separate element attached to the bracket arm 120, or a structure machined into or bonded to the bracket arm 120. The hemisphere element 134, cup element 136, adjustment plate 138, and any attached arm 120 are connected to the base 132 with a ball-end socket 140. The ball-end socket 140 includes an opening 142 which may be threaded, or include other connection means to receive an extension from knob 144 (See FIGS. 3 and 4) to secure and tighten the ball joint 116 at selected angles.

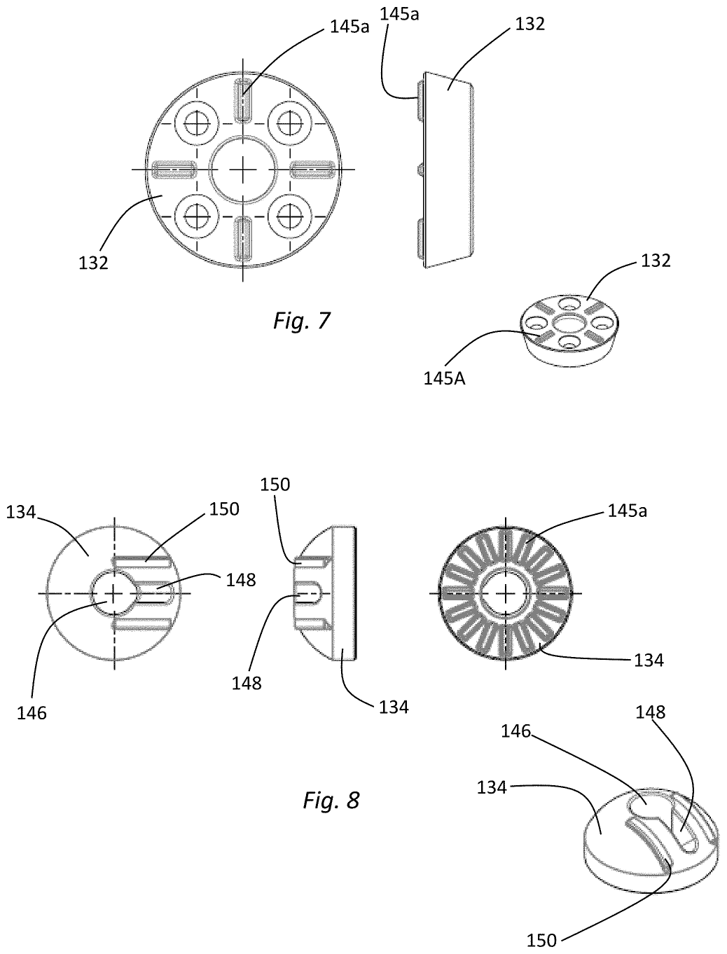

When assembled, the ball-end socket 140 extends through central holes in the base 132, hemisphere element 134, cup element 136, and adjustment plate 138. The ball portion of the ball-end socket 140 is captured by the base 132, such that the ball-end socket 140 cannot be pulled through the base 132 but can pivot or swing freely within a range of motion. The hemisphere element 134 is, in use, held firmly against the base and substantially prevented from movement relative to the base by the engagement of corresponding key and socket elements 145a and 145b, see FIGS. 7 and 8. As shown in FIG. 8, the hemisphere element 134 may be formed with a relatively large number of key and socket elements 145b, relative to the corresponding elements 145a on the base 132, permitting the orientation of the hemisphere element 134 to be adjusted at selected rotational angles relative to the base 132, which in turn adjusts the orientation of the angular adjustment plane.

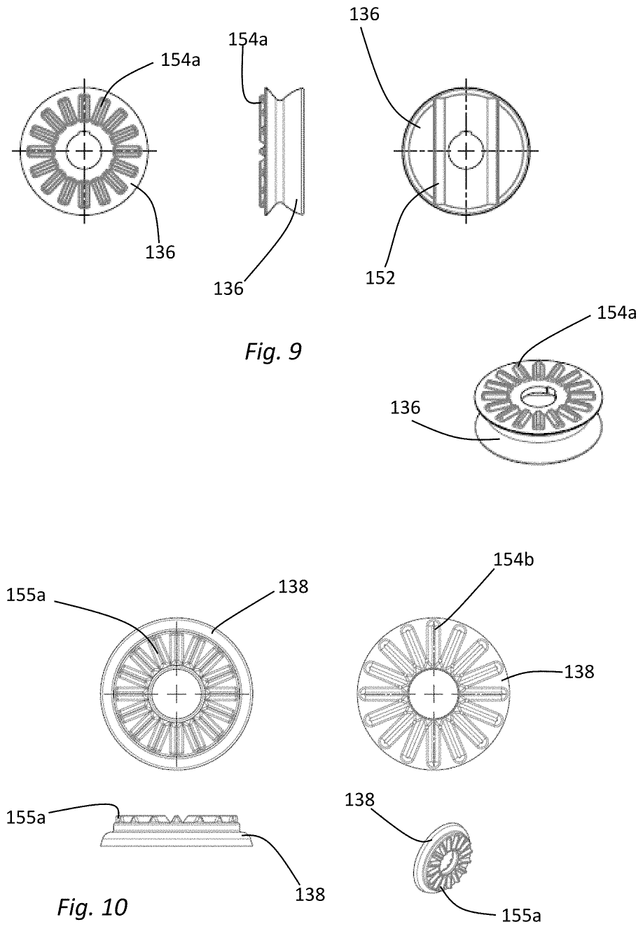

As best shown in FIG. 8, the hemisphere element 134 includes a central hole 146 opening into a slot 148. In use, the central shaft of the ball-end socket 140 extends through the central hole 146 and can pivot into the slot 148. The hemisphere element 134 also includes one or more tracks 150 on an outer surface, parallel to the slot 148. As shown on FIG. 9, the tracks 150 can be received in corresponding grooves 152 on an inner surface of the cup element 136. The position of the track 150 and groove 152 elements could be reversed between the cup element 136 and the hemispherical elements 134. The inner surface of the cup element 136 defines a female hemispherical surface which mates with the corresponding male outer surface of the hemispherical element 134 such that the track 150 and groove 152 elements mesh together. When assembled, the inner surface of the cup element 136 can be slid or manipulated across the outer surface of the hemispherical element 134 parallel to the tracks 150 and groove 148. This motion permits angular adjustment within the ball joint 116.

The side of the cup element 136 opposite the female hemispherical surface includes a second set of key or socket elements 154a that engage with mating key or socket elements 154b on the adjustment plate 138 when the ball joint 116 is assembled. A third set of key or socket elements 155a may engage with mating key and socket elements attached to or machined into the arm 120.

When assembled, as shown in FIG. 5, the shaft of the ball-end socket 140 extends through the central holes of each component. When the cup element 136 slides across the outer surface of the hemispherical element 134 to provide angular adjustment, the central shaft of the ball-end socket 140 extends into the slot 148 of the hemispherical element 134 while the ball-end pivots against the base 132. Adjustment of the orientation of the angular adjustment plane defined by the slot 148 and tracks 150 may be accomplished by adjusting engagement between key and socket elements 145a and 145b.

Supplemental adjustment of the arm 120 in a plane generally parallel to the lengthwise axis of a post 114 may be accomplished by adjusting the engagement between key and socket elements 154a and 154b, or by adjusting engagement between key and socket elements 155a and the arm.

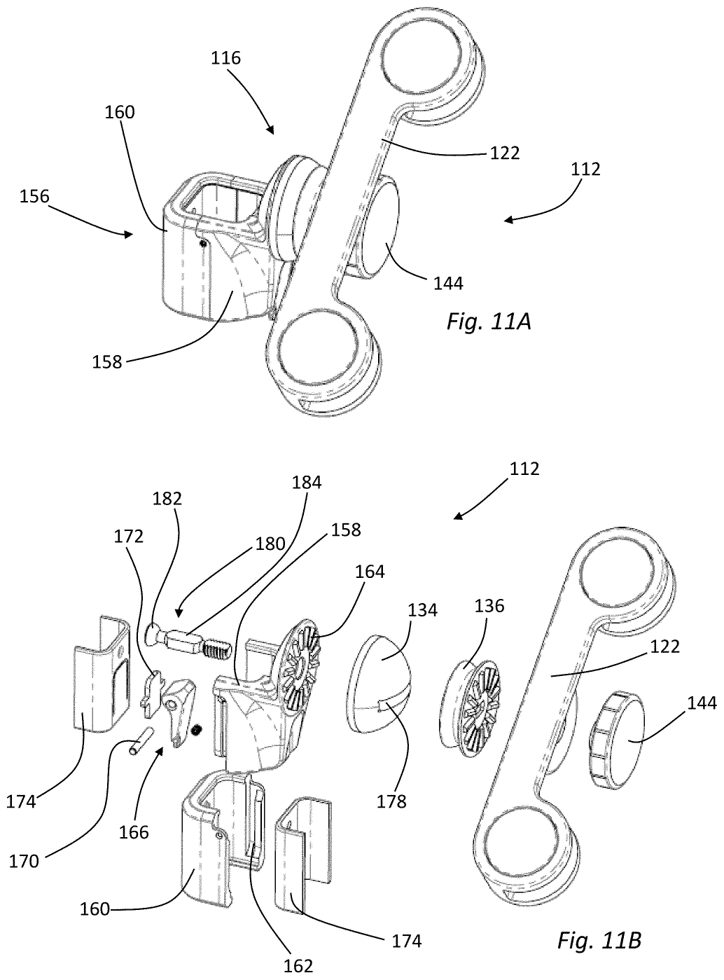

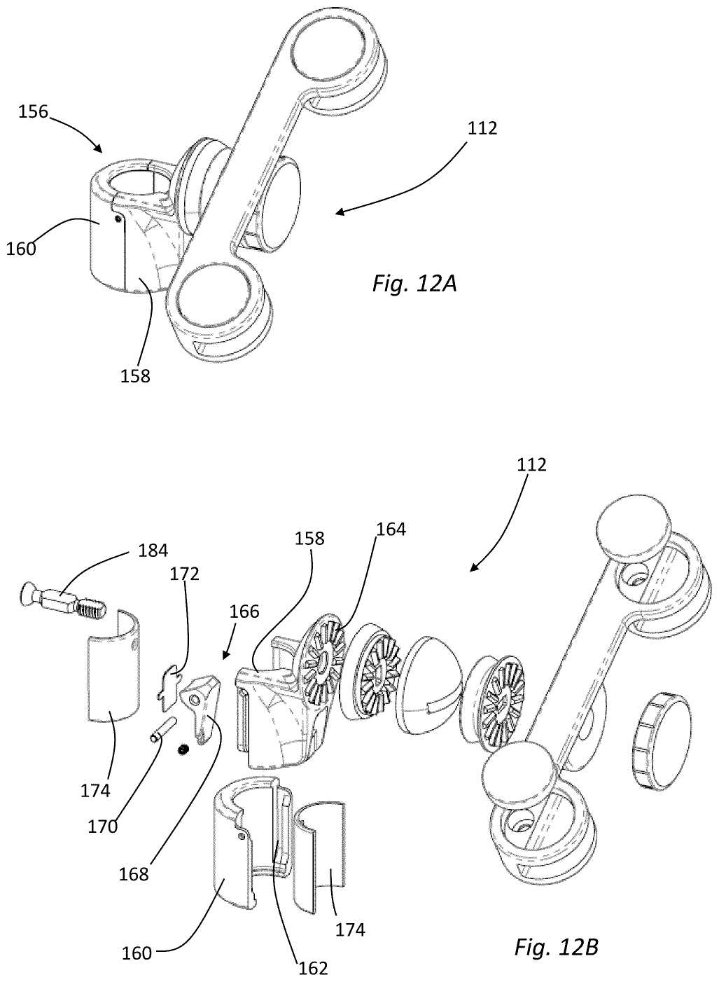

FIGS. 11 and 12 show alternative embodiments of a panel support 112 with additional adjustment capability. Each of the FIG. 11 and FIG. 12 embodiments are attached to a corresponding post with a supplemental clamp assembly 156. The clamp assembly 156 of the FIG. 11 embodiment is configured to clamp a square post 114. The clamp assembly 156 of the FIG. 12 embodiment is configured to clamp a round post.

In each embodiment, the clamp assembly 156 includes first and second clamp portions 158 and 160 respectively, that can be joined together by sliding mating slot and keyway structures 162 into engagement with each other. As shown in FIG. 11B and FIG. 12B, the first half 158 of the clamp 156 supports an integrated base 164 for a ball joint similar to that described above.

A clamp assembly 156 may optionally include a quick release structure 166 including a cam lever 168, a pivot pin 170, a spring plate 172 and a pressure sheath 174. In the illustrated embodiment, when the cam lever 168 is raised, pressure on the pressure sheath 174 against a corresponding post 114 is released and the vertical position of the entire panel support 112 on the post 114 may be adjusted. When the cam lever 168 is lowered, the panel support 112 is locked into place.

The ball joint 116 of the FIG. 11 and FIG. 12 embodiments operates in a similar manner to the ball joint 116 described with respect to FIGS. 5-10. Certain elements common to both embodiments are configured somewhat differently. For example, the hemispherical element 134 of the FIGS. 11 and 12 embodiments includes a slot 178 extending through the hemispherical element 134 to both the front and back of a vertical centerline. In addition, the attachment rod 180 includes only a portion of a ball 182 at an end which engages the first clamp half 158 and extends through the hemispherical element 134, cup element 136, bracket 122 to a threaded engagement with the tightening knob 144. In addition, the attachment rod 180 includes opposing flat surfaces 184 which, when the ball joint 116 is assembled, engage with the upper and lower surfaces of the slot 178 extending through the hemispherical element 134. This engagement provides for smooth articulation of the ball joint 116 in a plane perpendicular to the lengthwise axis of a corresponding post 114 when the knob 144 is loosened.

Each of the embodiments disclosed herein includes various knobs and threaded engagement with tightening elements including knobs 130, 144, and 126. These knobs permit the installation, removal, and adjustment of the position of a panel 102 in various planes without the use of tools.

Having described certain exemplary embodiments, it will be understood by those skilled in the art that many changes in construction and widely differing embodiments and applications of the invention will suggest themselves without departing from the scope of the present invention. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise.

What is claimed is:

1. A food shield system comprising:
a stand comprising a post;
a panel support bracket attached to the post and attached to a food shield panel away from the post; wherein the panel support bracket comprises:
a ball joint positioned between the attachment to the post and the attachment to the food shield panel, wherein the ball joint includes at least one hemispherical surface providing for an adjustment of an angular orientation of the panel relative to the stand.

2. The food shield system of claim 1 wherein the ball joint further comprises:
a male hemispherical surface on a first ball joint element; and
a female hemispherical surface on a separate second ball joint element, wherein the male and female hemispherical surfaces of the first and second ball joint elements are operationally held in moveable engagement with each other by a threaded element extending through the first ball joint element and the second ball joint element.

3. The food shield system of claim 2 wherein the ball joint further comprises:
a structured surface on one of the first and second ball joint elements opposite the male or female hemispherical surface; and
a mating structured surface on a third ball joint element, held in moveable engagement with the first or second ball joint element by the threaded element extending through the third ball joint element, wherein the moveable engagement between the third ball joint element and the first or second ball joint element provides for an additional adjustment of the position of the food shield panel relative to the attachment of the panel support bracket to the post.

4. The food shield system of claim 3 wherein the ball joint further comprises a knob in threaded engagement with the threaded element, such that threading or unthreading the knob with respect to the threaded element provides for the moveable engagements between the first, second and third ball joint elements to be selectively loosened to permit movement between the first, second, and third ball joint elements or tightened to hold the first, second, and third ball joint elements together.

5. The food shield system of claim 3 wherein the panel support bracket further comprises a pivot assembly positioned between the ball joint and the attachment to the food shield panel, wherein the pivot assembly provides for adjustment of the angular orientation of the food shield panel around an axis along the length of the food shield panel.

6. The food shield system of claim 1 wherein the panel support bracket is attached to a flat surface of the post with screws.

7. The food shield system of claim 1 wherein the panel support bracket is attached to the post with an adjustable clamp providing for adjustment of the vertical position of the panel support bracket along the post.

8. The food shield system of claim 7 wherein the adjustable clamp comprises:
a first clamp portion; and
a second clamp portion attached to the first clamp portion by engagement between a slot formed in one of the first and second clamp portions and a mating keyway formed in the other of the first and second clamp portions.

9. The food shield system of claim 7 wherein the adjustable clamp further comprises:
a cam lever; and
a pressure sheath positioned to be pressed against the post by the cam lever to selectively tighten or loosen the adjustable clamp from the post by manually articulating the cam lever.

10. A food shield panel support comprising:
a post attachment structure;
a food shield panel attachment structure; and
a ball joint positioned between the post attachment structure and the food shield panel attachment structure, wherein the ball joint includes at least one hemispherical surface providing for an adjustment of an angular orientation of the food shield panel attachment structure relative to the post attachment structure.

11. The food shield panel support of claim 10 wherein the ball joint further comprises:
a male hemispherical surface on a first ball joint element; and
a female hemispherical surface on a separate second ball joint element, wherein the male and female hemispherical surfaces of the first and second ball joint elements are operationally held in moveable engagement with each other by a threaded element extending through the first ball joint element and the second ball joint element.

12. The food shield panel support of claim 11 wherein the ball joint further comprises:
a structured surface on one of the first and second ball joint elements opposite the male or female hemispherical surface; and
a mating structured surface on a third ball joint element, the third ball joint element being held in moveable engagement with the first or second ball joint element by the threaded element extending through the third ball joint element, wherein the moveable engagement between the third ball joint element and the first or second ball joint element provides for a secondary adjustment of the position of the food shield panel attachment structure relative to the post attachment structure.

13. The food shield panel support of claim 12 wherein the ball joint further comprises a knob in threaded engagement with the threaded element, such that threading or unthreading the knob with respect to the threaded element provides for the moveable engagements between the first, second, and third ball joint elements to be selectively loosened to permit movement between the first, second, and third ball joint elements or tightened to hold the first, second, and third ball joint elements together.

14. The food shield panel support of claim 12 further comprising a pivot assembly positioned between the post attachment structure and the food shield panel attachment structure, wherein the pivot assembly provides for a tertiary adjustment of the orientation of the food shield panel attachment structure relative to the post attachment structure.

15. The food shield panel support of claim 10 wherein the post attachment structure comprises an adjustable clamp.

16. The food shield panel support of claim 15 wherein the adjustable clamp comprises:
a first clamp portion; and
a second clamp portion attached to the first clamp portion by engagement between a slot formed in one of the first and second clamp portions and a mating keyway formed in the other of the first and second clamp portions.

17. The food shield panel support of claim 16 wherein the adjustable clamp further comprises:
a cam lever; and
a pressure sheath positioned to be pressed by the cam lever to selectively tighten or loosen the adjustable clamp.

18. A method of positioning a food shield panel comprising:
providing a food shield system comprising:
a stand comprising a post;
a panel support bracket attached to the post and attached to a food shield panel away from the post; wherein the panel support bracket comprises;
a ball joint positioned between the attachment to the post and the attachment to the food shield panel, wherein the ball joint includes at least one hemispherical surface; and
adjusting the angular orientation of the panel relative to the stand by articulating the ball joint at the hemispherical surface.

19. The method of claim 18 further comprising:
providing the ball joint with:
a male hemispherical surface on a first ball joint element;
a female hemispherical surface on a separate second ball joint element;
a structured surface on one of the first and second ball joint elements opposite the male or female hemispherical surface;
a mating structured surface on a third ball joint element; and
a threaded element extending through the first, the second, and the third ball joint elements to hold the male and female hemispherical surfaces in moveable engagement and to hold the structured surface and the mating structured surface in moveable engagement; and
adjusting the position of the food shield panel relative to the attachment of the panel support bracket to the stand by articulating the engagement between the structured surface and the mating structured surface.

20. The method of claim 19 further comprising:
providing a pivot assembly positioned between the ball joint and the attachment to the food shield panel; and
adjusting the angular orientation of the food shield panel around a lengthwise axis of the food shield panel by articulating the pivot assembly.
